(19) United States
(12) Patent Application Publication
(10) Pub. No.: US 2018/0017463 A1
(43) Pub. Date: Jan. 18, 2018

(54) Method for forming pressure-testable field joint between pre-insulated pipe sections, and piping system with pressure-testable field joint

(71) Applicant: LAWRENCE JOSEPH STONITSCH, COAL CITY, IL (US)

(72) Inventor: LAWRENCE JOSEPH STONITSCH, COAL CITY, IL (US)

(21) Appl. No.: 15/541,885

(22) PCT Filed: Dec. 21, 2015
(86) PCT No.: PCT/US15/67096

§ 371 Date: Jul. 6, 2017

Related U.S. Application Data
(60) Provisional application No. 62/101,533, filed on Jan. 9, 2015.

(51) Int. Cl. G01M 3/28; B29C 65/34; B29C 44/12; B29C 65/82; B29C 65/00; F16L 59/20

(52) U.S. Cl. CPC G01M 3/2861; B29C 66/73921; F16L 59/20; B29C 44/1295; B29C 65/8246; B29C 65/3468; F16L 2201/30

(57) ABSTRACT

A method for forming a field joint between pipe sections is provided, preferably for pre-insulated pipe sections containing a carrier pipe surrounded by insulation and an outer jacket. The carrier pipes are joined, and an air tube is positioned so that its first end is within the joint area, and its second end extends beyond the joint area. A sleeve is sealed over the joint area, joining the jackets, with the sleeve positioned to cover the first end but not the second end of the tube. Air is injected into the tube to pressurize the cavity within the jacket, and the tube bore is sealed to allow air pressure testing. If the testing shows no loss of air pressure, the bore of the tube is sealed permanently to complete the seal on the field joint. Also provided is a piping system having a field joint formed by this method.

### CROSS-REFERENCE TO RELATED APPLICATIONS

This application is the U.S. national phase of PCT/US2015/067096 filed Dec. 21, 2015. This application claims the priority and benefit of U.S. Provisional Patent Application Ser. No. 62/101,533, filed on Jan. 9, 2015. The complete and entire disclosures of said U.S. Provisional Patent Application Ser. No. 62/101,533 filed Jan. 9, 2015, and International Application No. PCT/US2015/067096 filed Dec. 21, 2015, are hereby incorporated by reference herein.

### BACKGROUND OF THE INVENTION

The present invention relates to a method for forming pressure testable field joints between sections of pre-insulated pipes used to convey fluids at hot and/or cold temperatures, particularly for energy distribution systems in cities, schools, prisons, military bases, industrial plants, and the like. The invention further relates to piping systems having field joints made with pressure-testable connection between pre-insulated pipe sections.

Underground piping systems for steam and hot water heating of buildings in an area such as a city, campus, or the like, from a central heating plant serving the entire area, are known in Europe and have been used in the United States primarily in institutional settings. Since about 1947, central cooling systems too are known and used in American cities such as Chicago. Insulation has been used about the carrier pipes in such systems, including simple enclosed air spaces in conduits and tunnels and also insulating materials such as mineral wool, fiberglass batting, and foams of polyurethane and the like. Over time, however, the insulation in many such systems can deteriorate and become inefficient because of moisture getting into the insulation from condensation or ground water (as from flooding) as well as from thermal movement of the pipes during heating-up and cooling-down cycles. Various known methods are directed to replacing that insulation in place.

Air space or insulation is used about the central pipe and within the outer conduit in sections of pipe built for new and replacement installations of underground piping systems. For instance, U.S. Pat. No. 4,240,850 shows assembly of a sleeve creating an air space fillable with foam insulation about an inner pipe, using circumferentially extending, apertured spacers. U.S. Pat. No. 3,877,136 applies foam insulation to and then forms a spiral-walled tube about an inner pipe. U.S. Pat. No. 3,709,751 covers a foam layer about a pipe with a thin plastic sleeve. Installations with multiple pipes within larger outer conduits and in tunnels are known. High-performance polyisocyanurate and similar foams for use in such insulating applications are known from U.S. Pat. No. 4,904,703 and U.S. Pat. No. 5,732,742.

Pre-insulated piping systems have been used to distribute hot and cold fluids in these sorts of above and below ground applications. The length of a section of pre-insulated pipe is usually 20 or 40 feet long. The sections of pipe are pre-insulated, usually at the factory. The pre-insulated pipe sections are then joined together in the field by the installer. In a pre-insulated pipe section, the end, i.e., the field joint area, is purposely left un-insulated, so that the end of the carrier pipe can be welded to the end of the carrier pipe in the next section, and then the newly formed carrier pipe joint can be pressure tested prior to being insulated. Especially in situations where the piping system is going to be buried, the insulated joint area is sealed with materials that will assure the joint insulation materials will be kept dry. If the insulation becomes wet, it no longer reduces the loss of temperature for heating, or gain in temperature for cooling systems. Moisture in the field joints can also contribute to corrosion of the primary (inner/carrier pipe) often causing the piping system to fail prematurely.

The pre-insulated pipe industry knows that the field-insulated joint is truly the weakest link in the system. Pipe insulating systems are subject to failure and suffer from poor insulating properties if joints made between pre-insulated sections are not formed and sealed properly, and thus allow incursion of air and/or moisture into the joint areas. Numerous approaches to proper sealing, waterproofing, and pressure testing have been tried. Some have failed due to lack of skill of the installer, improper testing of the finished product, and use of the wrong products. It is therefore important to conduct air pressure testing on newly formed joints to assess whether the newly formed joints are properly sealed, and therefore form air-tight and water-tight insulated areas around the carrier pipe.

At the present time, the standard method of testing the field joint for air-tightness and water-tightness is to apply the insulating materials and covering materials, usually ending with an outermost layer comprised of a high density polyethylene joint cover, which is then fully sealed onto the joint. Then the installer drills a hole in the completed high density polyethylene joint cover, and inserts an air test apparatus into this drilled hole. The installer then uses the apparatus to inject air through this drilled test hole under pressure (usually 5 PSI) inside of the joint closure area, and takes air pressure measurements using the apparatus, to test if the newly formed joint is air/water tight. If the joint passes the air pressure test, then the installer removes the air test apparatus from the test hole, and seals the test hole where the pressure test apparatus was inserted. This known method of drilling of a test hole, testing, and then patching, is illustrated in FIGS. 10-13 of U.S. Pat. No. 5,736,715.

There are various ways to patch and seal this test hole, and this process can result in a good product, but the effectiveness of the sealing of this test hole relies heavily on the skill of the workman. The invention herein solves the problem of how to make and test field joints without the possible sealing failures that result from cutting a hole in a perfectly good joint cover in order to test the joint, and then patching the test hole, hoping the installer patches the test hole properly and that an air-tight and water-tight seal is maintained after the test. The invention herein allows installers to ensure that they have made high quality, water-tight and air-tight joint closure at the piping system's field joint, in a very simple and inexpensive manner, without requiring use of any specialized electronic equipment to air test the joint after it has been made, or to repair an area where a test shows that the joint area is not fully sealed.

### BRIEF SUMMARY OF THE INVENTION

The inventor has discovered an improved field joint for use in piping systems, and a method of forming a field joint between pre-insulated pipe sections, including the step of inserting an air tube into the space between the joined carrier pipe and the outer jacket joint, prior to completion of the seal of the outer jacket joint, thereby allowing the installer access to test the seals in the joined carrier pipe and joined outer jacket in an improved manner, without drilling a test hole in the completed outer jacket joint. The installer tests the seals by pumping air into the air tube so as to pressurize the space between the carrier pipe and the outer jacket, and then finding any faults in the seals by detecting escape of air from the pressurized space. After any needed repairs and final testing of the seals are conducted, the air tube bore is sealed off from the exterior environment.

### BRIEF DESCRIPTION OF THE DRAWINGS

FIG. 1 is a diagram representing a cross-sectional view of a pre-insulated pipe section taken along line 1-1 of FIG. 2.

FIG. 2 is a diagram representing a cross-sectional view of two pre-insulated pipe sections with ends adjacent to one another, prior to completion of a field joint according to the invention.

FIG. 3 is a diagram representing a cross-sectional view of pre-insulated pipe sections after joining carrier pipe and adding carrier pipe insulation segments according to the invention.

FIG. 4 is a perspective view of two carrier pipe insulation segments shown prior to application to the joint area.

FIG. 5 is a diagram representing a cross-sectional view of pre-insulated pipe sections after adding sealant to the outer jacket.

FIG. 6 is a diagram representing a cross-sectional view of pre-insulated pipe sections after adding an air tube.

FIG. 7 is a diagram representing a cross-sectional view of pre-insulated pipe sections after sliding sleeve to cover the jacket gap and a portion of the air tube.

FIG. 8 is a diagram representing a cross-sectional view of pre-insulated pipe sections after sliding sleeve to cover the jacket gap and a portion of the air tube, under another embodiment of the invention.

FIG. 9 is a diagram representing a cross-sectional view of pre-insulated pipe sections after shrinking the sleeve to cover the jacket gap.

FIG. 10 is a perspective view of the formed field joint with an outwardly extending portion of the air tube ready for air testing.

FIG. 11 is a perspective view of the tested field joint after cutting excess air tubing.

FIG. 12 is a perspective view of the field joint after application of shrink wrap.

### DETAILED DESCRIPTION OF THE INVENTION

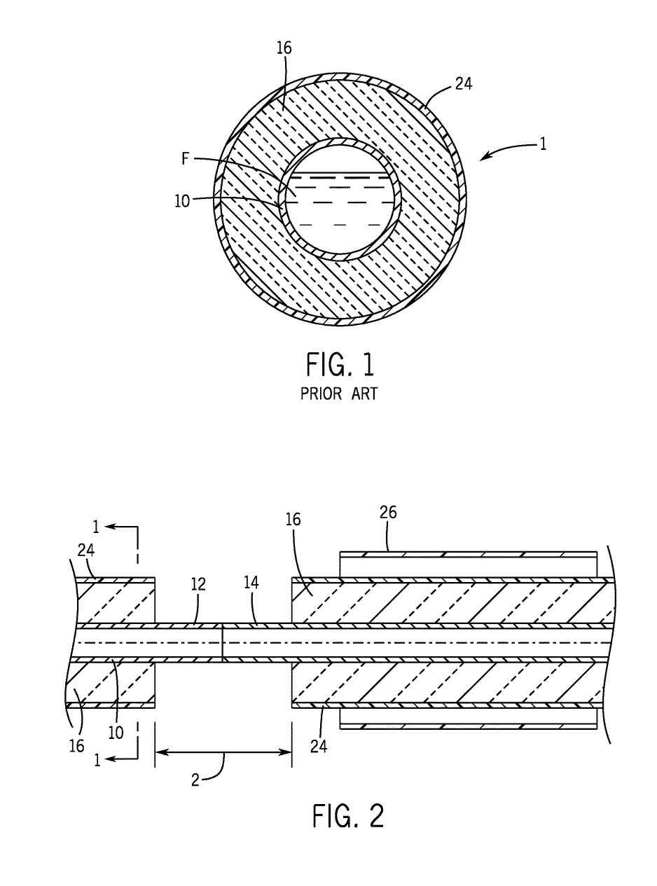

Pre-insulated piping 1 used in the method of this invention is shown in the drawings. FIG. 1 shows a cross-sectional view taken along line 1-1 of FIG. 2 of a section of pre-insulated piping 1 containing a carrier pipe 10. Each pre-insulated pipe section comprises an interior carrier pipe 10 of a suitable diameter, wall thickness, and material, such as iron, steel, copper, PVC, polyethylene, thermoplastics, fiberglass, and the like, all chosen in view of the material, volume flow, pressures, and temperatures of the fluid F to be carried inside the carrier pipe 10 during its life, for example, hot or cold liquids or vapors, such as steam or water. This inner carrier pipe 10 is arranged within an outer jacket 24, and a space between the inner carrier pipe and the outer jacket along the longitudinal axis of the pipe section contains an insulating layer. In an embodiment of the invention, the space between the inner carrier pipe 10 (e.g., a conduit) and the outer jacket 24 does not contain an insulating layer, and the space between the carrier pipe 10 and outer jacket 24 is maintained by suitable supports. In an embodiment of the invention, the carrier pipe 10 is arranged essentially coaxially within the outer jacket 24.

In pre-insulated pipe sections, the carrier pipe 10 is surrounded along its length in the axial direction by a carrier pipe insulating layer 16, as shown in FIG. 1. The carrier pipe insulating layer 16 is advantageously a factory-applied high temperature foam, such as urethane, polyisocyanurate, polyurethane, and urethane-modified polyisocyanurate foams applied in any known manner. When properly used, polyisocyanurate foam has an excellent low heat transmission- or K-factor of 0.14 at 73° F., as compared to the higher K-factor of other commonly used insulating materials, such as fiberglass at 0.28, mineral wool at 0.31, calcium silicate at 0.32, and foamglass at 0.41, corresponding to insulating- or R-values of 7, 3.6, 3.2, 3.1, and 2.4 per inch thickness of material, respectively.

The carrier pipe insulating layer 16 is surrounded along its length in the axial direction by an outer jacket 24, which serves as the outermost layer of the pre-insulated pipe section, as shown in FIG. 1. The jacket 24 is formed of suitable metallic or thermoplastic material, preferably of high density polyethylene (HDPE), and preferably is rigid so that the jacket 24 is resilient against pressures from the exterior, so as to prevent deformation of the insulating layer 16 that is disposed between the jacket 24 and the carrier pipe 10. The jacket is applied or affixed to the pre-insulated pipe section in the factory.

FIG. 2 shows a diagram representing a cross-sectional view of two pre-insulated pipe sections that have been placed into position with their respective ends 12, 14 abutting one another, prior to formation of a field joint according to the invention. In typical pre-insulated pipe sections, the ends 12, 14 are purposely manufactured without the insulating layer 16 and the jacket 24, so that the ends of the carrier pipe 10 are exposed, such that the end of the carrier pipe 10 in one pipe section can be welded to the end of the carrier pipe 10 in the next adjoining pipe section. Thus, at the early point in the field joint formation process shown in FIG. 2, there is a gap between the ends of the insulating layers 16 and the jackets 24 of two abutting pipe sections in the joint area 2 between adjacent carrier pipe sections. Then, after the carrier pipe joint has been formed, the carrier pipe joint can be pressure-tested prior to addition of insulation to surround the newly formed carrier pipe joint and the formation of an outer jacket joint around the carrier pipe joint.

As shown in FIG. 2, preferably prior to joining the ends of the carrier pipe 10 in the two adjoining pipe sections, a full, continuous round sleeve or split sleeve 26 is movably positioned to surround the exterior of the jacket 24 of one of the two pre-insulated pipe sections to be joined together, by being slid onto the section before joining of the carrier pipe ends, or being wrapped around the jacket 24. The sleeve 26 is a segment having a roughly tubular shape with an optional split opening formed in the direction of its longitudinal axis. The optional split allows the sleeve to flex open slightly as needed to allow flexibility in the sleeve to be moved and positioned over the joint area 2.

The sleeve 26 is formed of suitable thermoplastic material, preferably of polyethylene, more preferably of high density polyethylene (HDPE). The sleeve 26 optionally may be formed of the same material as the jacket 24 to which it will be affixed and sealed. The sleeve 26 may preferably be made in a specific size in diameter as well as other dimensions and then is heated and expanded. The expanded sleeve 26 is then of a size to be slid into its initial position surrounding the jacket 24 of one of the sections of pre-insulated pipe. Then, later in the process, after being centered over the field joint area 2 and heated again, by the nature of the heat-shrinkable material of which it is formed, the sleeve 26 will shrink back down to smaller dimensions to closely surround the joint area 2.

The sleeve 26 can alternatively be made of a wrap-around sheet material that is formed into a tubular shape and sealed, being sized to be slid into the initial position surrounding the jacket 24 of one of the sections of pre-insulated pipe. Then, later in the process, after being centered over the field joint area 2 and heated again, by the nature of the heat-shrinkable sheet material, the sleeve 26 will shrink back down to smaller dimensions to closely surround the joint area 2.

As shown in FIG. 2, preferably after the sleeve 26 has been positioned around one of the adjoining pipe sections, the ends of the carrier pipe 10 of the abutting pre-insulated pipe section ends 12, 14 are welded or soldered together using any conventional welding or soldering technique suitable to the material of the carrier pipe 10, so as to form an air-tight and water-tight seal in the joint between the two ends of the carrier pipe 10. The seal of this carrier pipe joint can preferably then be tested, if desired, to check for a tight seal against incursion or excursion of fluids into or out of the newly formed joint between the ends of the adjoining carrier pipes.

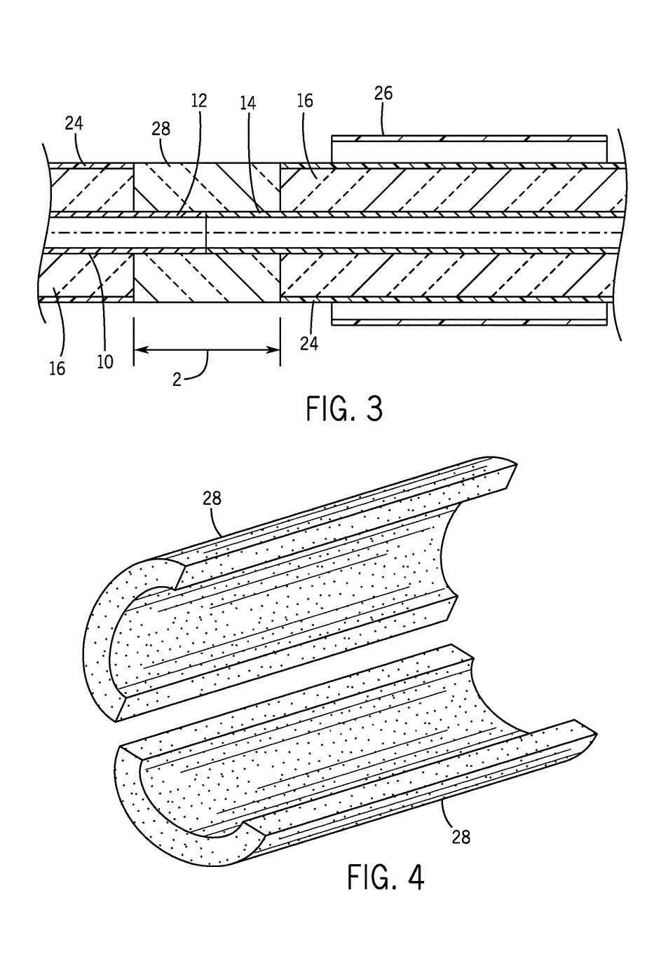

Next, as shown in FIG. 3, the gap in the carrier pipe insulating layer 16 is filled by adding insulation to the gap. Preferably, a carrier pipe insulation segment 28 is added to fill in the gap in the carrier pipe insulating layer 16 around the point of the newly formed joint in the carrier pipe 10.

There are several known ways of adding this insulation segment 28, including field mixing liquid foam and pouring it into a mold that surrounds the gap, or installing into this gap pre-formed sections of insulation shaped to fit around the carrier pipe 10. FIG. 4 shows an example of the insulation segment 28 in the form of a pre-formed section of insulation made of foam, for example polyisocyanurate foam, prior to its application onto the newly-formed joint in the carrier pipe 10. The pre-formed section may preferably be in a tubular shape, formed to fit around the carrier pipe 10. The tubular-shaped, pre-formed section may preferably be split into two parts as shown in FIG. 4 along a longitudinal axis of the tubular-shaped section to facilitate its application around the new joint. Any voids in the insulation segment 28 thus added can be filled in, for example by stuffing in loose insulation or injecting an expanding liquid foam, to ensure there will be no voids in coverage of the insulation segment 28 over the newly formed carrier pipe joint.

After installation of the insulation segment 28, all surfaces of the jacket 24 that are to be bonded to the sleeve 26 are cleaned and wiped to assure good adherence between the jacket 24 and the sleeve 26. The cleaning can be performed with 24 grit abrasive cloth. The jacket surface in this area is then wiped to remove any debris on the portions of the surface of the jacket 24 to be bonded.

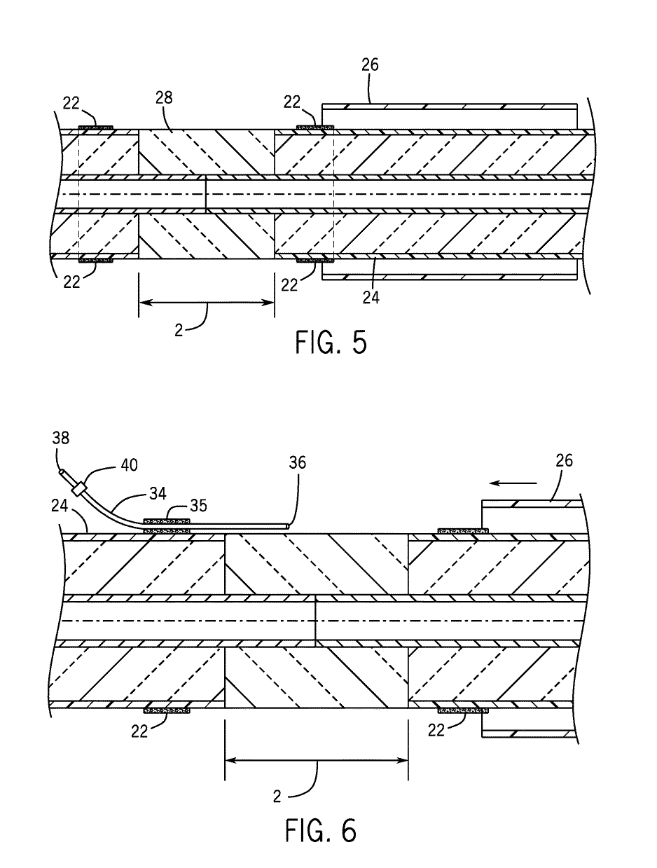

FIG. 5 shows the steps of marking and applying a sealant band on the jacket 24 of each one of the ends of the adjoining pipe sections. The positions where each of the two ends of the sleeve 26 will lie after the sleeve 26 is centered over the joint area 2 are marked. The positions of the marks are schematically indicated as dotted lines between bands of sealant, depicted as reference numerals 22, 22 in FIG. 5. Using the markings, a sealant 22 is applied around the outer circumference of a longitudinal segment of the jacket 24 on each of the two ends 12, 14 of the adjoining pipe sections, as shown in FIG. 5. On each of the two segments, the layer of sealant 22 is applied onto at least a two inch wide strip circumferentially surrounding the outer surface of the jacket 24, in a position set by the markings, positioned so as to abut and adhere to the inner surface of the sleeve ends, after the sleeve 26 has been centered over the joint area 2. In this manner, the outermost two inches or so of each of the two lateral ends of the sleeve 26 will be affixed to the jacket 24 via the sealant 22 adhering and forming a seal between the sleeve 26 and the jacket 24 at the sleeve's lateral ends. The sealant 22 is preferably a high temperature elastomeric sealant that will form an air- and water-tight seal between the sleeve 26 and the jacket 24.

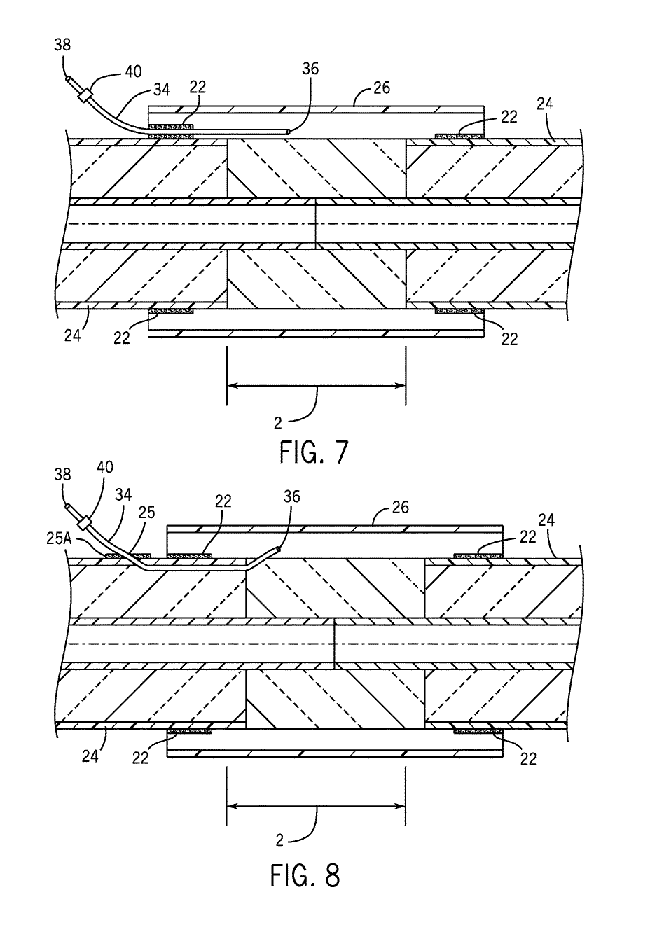

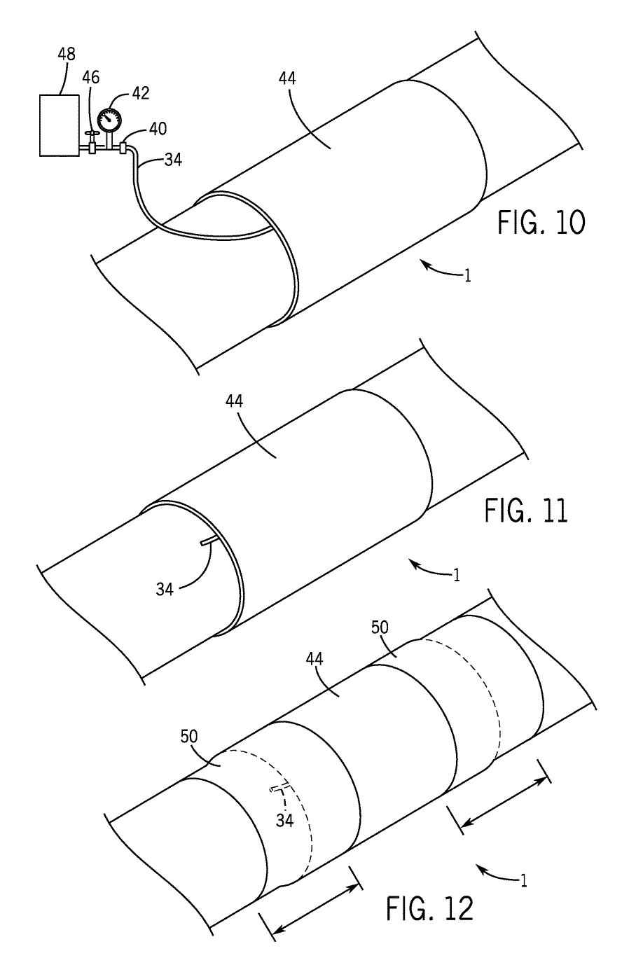

As shown in FIG. 6, after the application of the sealant 22 to the ends of the jacket 24, an air tube 34 is positioned on the surface of the end 12 of one of the pre-insulated pipe sections 1. This air tube 34 is preferably formed of a suitable thermoplastic or metallic material, more preferably copper, and is of a small diameter, in the range of approximately ⅛ inch diameter. A suitable length of the tube 34 is about 12 inches. A first open end 36 of the air tube 34 is positioned so that the end 36 of the air tube 34 with its open interior bore is positioned within the joint area 2, in the insulation segment 28 or resting on top of the insulation segment 28. The second open end 38 of the air tube 34 is positioned to extend beyond the end of the joint area 2, as depicted in FIG. 6, so that the second open end of the bore of the air tube 34 will still be exposed to the exterior environment after the sleeve has been slid (in the direction indicated by the arrow) into position covering the joint area 2. The second end 38 of the air tube 34 preferably includes or is fitted with a connector, in the nature of a coupling 40, shown in FIG. 7. The coupling 40 is adapted to form a sealed, air-tight connection between the bore of the air tube 34 and a pump or testing apparatus 48 (shown schematically in FIG. 10) to be connected to the bore of the air tube 34 through the coupling 40.

With the air tube 34 in the position as depicted in FIG. 6, the tube 34 is then fixed into place by applying an additional sealant section 35 over the air tube 34. The sealant section 35 is preferably about a two inch by two inch square section of sealant material that is similar to that of the sealant 22. This sealant section 35 holds the air tube 34 in position while the sleeve 26 is moved into position.

Then, as shown in FIG. 7, the sleeve 26 is moved into position over the joint area 2 so that the sleeve 26 surrounds the end portions of the jacket 24 of each end 12, 14 of the pre-insulated pipe sections, over the entire joint area 2. Also when moved into this position, the ends of the sleeve 26 are positioned to abut the segments of sealant 22 on the outer surface of the jacket. The sleeve 26 thus covers the first end 36 of the air tube 34. The sleeve 26, when in this position, does not cover the second end of the air tube 38, as is depicted in the view shown in FIG. 7, such that the second end 38 of the air tube 34 remains outside the joint area 2 and exposed to the exterior environment.

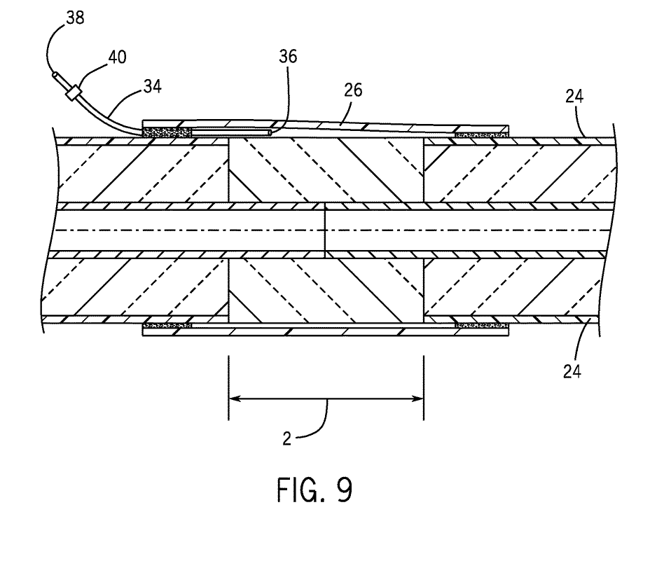

Thereafter, as shown in FIG. 9, the sleeve 26 is sealed to the jacket 24. The sealant 22 forms a seal between the inner surfaces of the lateral ends of the sleeve 26 and the outer surface of the jacket 24. The seal can, if appropriate to the materials, be formed by a welding type of operation such as welding the sleeve material to that of the jacket ends. Upon completed formation of the jacket joint, the sleeve 26 entirely surrounds and covers the ends of the jacket 24 on the pre-insulated pipe sections, to form a sealed jacket joint between the sleeve 26 and the jacket 24.

The sleeve 26 preferably is, as described previously, formed of a heat-shrinkable material so that the seal between the sleeve 26 and the jacket 24 can be formed by applying heat to the exterior surface of the sleeve 26 so that the entire circumference of the sleeve 26 shrinks down so that the sleeve 26 closely fits onto and fuses with the outer surface of the jacket 24. Thereby, the sealed jacket joint is formed. FIG. 7 shows the unsealed state of the jacket joint, with a gap between the jacket 24 and the sleeve 26, prior to the heat-shrinking of the sleeve 26, as contrasted to the sealed state of the jacket joint after the heat-shrinking of the sleeve 26 to closely surround the jacket 24 shown in FIG. 9. If the sleeve 26 is a split sleeve (wrap around) rather than a full round tube, the split edge of the sleeve 26 must similarly be sealed by sealant, heat-shrinking, or other conventional means so that the split is completely closed and a fully air-tight and water-tight sealed jacket joint is formed around the full circumference of the pipe joint area 2 by the adherence of the sleeve 26 to the outer surface of the jacket 24. In all these methods, the sealant 22 helps to create a full air- and water-tight seal between the interior surface of the ends of the sleeve 26 and the outer surface of the jacket 24 on each of the two pipe sections being joined.

As shown in FIG. 9, after the completion of formation of the fully sealed jacket joint, a portion of the air tube 34, including its second, outer end 38, remains outside the joint and open to the outside environment. An air-tight seal has thus been made that surrounds the exterior surface of the air tube 34 at the point at which the tube 34 extends outwardly from under the edge of the sleeve 26.

The formation of the fully sealed jacket joint 44 (see FIG. 10) thus forms a sealed cavity inside the sealed jacket joint 44. The sealed cavity in joint area 2 is depicted in FIG. 9. As seen in FIG. 9, the first end 36 of the air tube 34 is sealingly enclosed within the sealed cavity, and the second end 38 of the air tube remains outside the sealed cavity and exposed to an outside environment. The sealed cavity also contains the insulation segment 28.

Next, air-pressure testing is conducted to confirm that the seal of the sealed cavity inside the jacket joint 44 (depicted in FIG. 10) that has been formed in the outer jacket 24 is air-tight and water-tight. This is done by testing air-tightness of the sealed cavity within the sealed jacket joint 44. This test is conducted as follows, with the features schematically shown in FIG. 10.

First the installer connects the connector 40, which can preferably be any standard air tube fitting that provides a positive seal under air pressure, to an air pump apparatus, schematically shown as reference numeral 48 in FIG. 10. The connector 40 forms a sealed, air-tight connection between the bore of the air tube 34 and the air pump 48.

The air pump 48, thus connected to the air tube 34 via the connector 40, is then used to pump air through the bore of the air tube 34 into the sealed cavity within the outer jacket 24. The air pump 48 can be a simple known air pumping device such as a hand air pump, or a standard air compressor such as those conventionally used for pumping air into automobile tires. Such an air compressor typically comprises an air pumping means as well as an air pressure detection means 42 and/or shut off valve 46 that can be connected to the connector 40 of the air tube 34. A benefit of this invention is that these sorts of low cost, easily obtainable, standard compressor devices can be used as the air pump 48 for checking for air leaks by the claimed method. The standard devices often provide as well means to conduct the pressure testing function, and the shut off function. The shut off valve 46, as well as the air pressure detection means 42, which may preferably be in the form of a pressure gauge can alternatively be separate devices from the air pump 48.

Using the air pump 48, an air pressure above atmospheric pressure, preferably about 5 or so pounds per square inch (PSI), is created inside the cavity within the sealed jacket joint 44, by using the air pump 48 connected to the connector 40 of the air tube 34 to pump air into the air tube 34 through its outer end 38, through the bore in the air tube 34, into the space in the joint area 2, through the first (inside) end 36 of the air tube 34, which is positioned inside the cavity, thus pressurizing the cavity or space. The installer then temporarily closes off the outer end 38 of the air tube by closing the shut off valve 46 to prevent escape of air through outer end 38, to maintain the pressurization within the cavity. The installer then checks for air leaks in the cavity, by conventional means such as, e.g., listening for sounds of escape of the pressurized air through small holes in the sealed jacket joint 44, or soaping the joint area 2 to expose air leaks revealed by the visual cue of soap bubbles forming on the surface of the sealed jacket joint 44 in the joint area 2. The installer can also check for a drop in air pressure in the space between the joined carrier pipe 10 and the joined outer jacket 44 by reading air pressure measurements provided by the air pressure level detection means (pressure gauge) 42, which is connected to the end 38 of the air tube 34. The installer optionally may use a combination of such conventional means of detecting a change in the air pressure in the sealed cavity. The method thus allows the installer to find air leaks using inexpensive and readily available standard equipment. The installer is then enabled to easily make repairs in the seals of the newly formed jacket joint 44 as needed, and then to easily re-check for air leaks again after the repairs have been completed.

No leaking or drops in pressure mean a complete seal has been achieved. After this successful air pressure test has been completed, the air tube is disconnected from the air pump 48, shut off valve 46, and pressure gauge 42. Then the portion of the air tube 34 that extends outside end of the jacket joint 44 is preferably shortened by cutting off a portion of the air tube 34. Preferably the remaining portion of the cut air tube 34 extends about 1 inch outside the end of the jacket joint 44, as shown in FIG. 11. Then the bore of the air tube 34 is permanently sealed off from the outside environment. The bore sealing is conducted by injecting into the outer end of the bore of the air tube 34 flux, solder, a high temperature mastic, thermoplastic, or other sealing material, or combinations thereof, suitable to permanently and fully plug up and seal off the bore of the air tube 34. The bore sealing also can be performed by welding shut, or permanently crimping and collapsing the air tube 34 so that its bore is fully closed, so that an air-tight seal of the bore is accomplished.

The sealing of the bore results in a final air-tight and water-tight seal of the newly formed jacket joint 44 extending over the entire joint area 2. This yields a final air-tight and water-tight cavity in the joint area that contains insulation segment 28 and that is enclosed within the jacket joint 44 and surrounds the carrier pipe joint.

As shown in FIG. 12, if desired to counteract extreme environmental conditions, optionally an outer, secondary shrink-wrap covering 50, 50 can be sealed over each of the ends of the jacket joint 44. If desired, the covering 50, 50 can be sealed over the remaining portion of the cut air tube 34 that extends outside the jacket joint 44.

Also disclosed is another embodiment of the invention depicted in FIG. 8. FIG. 8 is a diagram representing a cross-sectional view of the pre-insulated pipe sections after a hole 25 has been drilled in the jacket 24 near one of the pre-insulated pipe section ends 12, and the air tube 34 has been inserted into the hole 25. In this embodiment, instead of the steps and arrangement of FIG. 7 wherein the air tube 34 is sandwiched between the sleeve 26 and the jacket 24 and then sealed therebetween, a hole 25 is drilled into the jacket 24 at a position that is outside the joint area 2, and that will be positioned beyond the end point of the sleeve 26 when the sleeve has been slid into position to cover the joint area 2. The hole 25 is shaped and sized to receive insertion of the air tube 34. The air tube 34 is inserted into the hole 25, and is fed inside the jacket 24 into a channel in the insulation layer 16, until the first end 36 of the air tube 34 is positioned so that the end 36 of the air tube 34 with its open interior bore is positioned within the joint area 2, in the insulation segment 28 or resting on the insulation segment 28.

As shown in FIG. 8, in this second embodiment, the second open end 38 of the air tube 34 is positioned to extend beyond the end of the joint area 2, so that, similarly to the arrangement and method as depicted in FIG. 7, the second open end of the bore of the air tube 34 will still be exposed to the exterior environment after the sleeve has been slid and sealed into its position covering the joint area 2. With the air tube 34 in the position as depicted in FIG. 8, the tube is then fixed into place and the remainder of the hole 25 fully closed and sealed off from the exterior environment by sealant 25A, which can be in the nature of a high temperature sealant such as a sealant patch, or of an HDPE weld. Similarly to FIG. 7, the second end 38 of the air tube 34 as illustrated in FIG. 8 preferably includes or is fitted with a connector, in the nature of a coupling 40. Similarly to the arrangement and method shown in FIG. 7, the coupling 40 is adapted to form a connection between the bore of the air tube 34 and a pump or testing apparatus 48 (shown schematically in FIG. 10) to be connected to the bore of the air tube 34 through the coupling 40, to conduct air leak tests similarly to those described above.

After sealing the sleeve 26 to the jacket 24 as described in the discussion above with regard to FIG. 9, and conducting the testing for airtightness and any necessary repairs to achieve an airtight seal as described above with respect to FIG. 10, then the portion of the air tube 34 extending outwardly from the hole 25 is preferably shortened by cutting off a portion of the air tube 34. Preferably the remaining portion of the cut air tube 34 extends about 1 inch outwardly from the hole 25. It is noted that in this second embodiment the cut air tube 34 will not be extending out from under the completed jacket joint 44 as shown with respect to the first embodiment shown in FIGS. 7 and 9.

Then the bore of the air tube 34 is permanently sealed off from the outside environment, by injecting into the remaining outer end of the air tube 34 flux, solder, a high temperature mastic, thermoplastic, or other sealing material, or combinations thereof, suitable to permanently and fully plug up and seal off the bore of the air tube 34 from the external environment. Other means of closing the bore optionally may be used, such as welding shut or crimping the tube, or otherwise collapsing and closing the open bore of the tube. Thus, in this second embodiment, the sealing of the bore results in a final air-tight and water-tight seal of the newly formed jacket joint 44 extending over the entire joint area 2. This embodiment has the benefit of avoiding any damage to the seal formed between the jacket 24 and the sleeve 26.

Also disclosed is a field joint made between pre-insulated pipe sections as described herein and schematically represented in FIGS. 1-12 herein. Also disclosed are piping systems comprising field joints made between pre-insulated pipe sections as described herein and schematically represented in FIGS. 1-12 herein.

While an exemplary embodiment incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on” another element or layer, it may be directly on, engaged, connected or coupled to the other element or layer, or intervening elements or layers may be present. As used herein, the term “and/or” includes any and all combinations of one or more of the associated listed items. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

### REFERENCE NUMERAL LIST

pre-insulated piping 1
joint area 2
carrier pipe 10
pre-insulated pipe section ends 12, 14
insulating layer 16
sealant 22
outer jacket 24
outer jacket hole 25
sealant for outer jacket hole 25A
sleeve 26
insulation segment 28
air tube 34
sealant section 35 over air tube
first end 36 of air tube 34
second end 38 of air tube 34
coupling 40 of air tube 34
pressure gauge 42
outer jacket joint 44
shut off valve 46
air pump/test apparatus 48
secondary shrink-wrap covering 50

1. A method for forming a field joint between adjacent pipe sections, each pipe section comprising an inner carrier pipe disposed inside an outer jacket with a space between the carrier pipe and the outer jacket, comprising:
forming a carrier pipe joint between ends of the carrier pipe of each of the pipe sections;
positioning an air tube so that a first end of the air tube is positioned within a joint area of the adjacent pipe sections, with a second end of the air tube positioned to extend beyond the joint area;
placing a sleeve over the joint area so that the sleeve surrounds the joint area and extends beyond a gap between the respective outer jackets of the pipe sections, wherein the sleeve is positioned so that it covers the first end of the air tube and does not cover the second end of the air tube;
sealing the sleeve to each of the respective outer jackets of the pipe sections such that a sealed jacket joint is formed between the respective jackets so as to form a sealed cavity inside the sealed jacket joint, wherein the first end of the air tube is sealingly enclosed within the sealed cavity, and the second end of the air tube remains outside the sealed cavity and exposed to an outside environment;
injecting air into a bore of the air tube at the second end of the air tube to pressurize the sealed cavity;
closing off the bore of the air tube to maintain the air pressure in the cavity;
testing for loss of air pressure inside the cavity; and
then permanently sealing off the bore of the air tube.

2. The method according to claim 1, wherein each of the pipe sections is a pre-insulated carrier pipe section, wherein the space between the inner carrier pipe and the outer jacket along the longitudinal axis of the pipe section contains an insulating layer.

3. The method according to claim 2, further comprising filling a gap between respective insulating layers of respective adjoining carrier pipe sections by adding insulation to the gap.

4. The method according to claim 3, wherein the insulation added to the gap is comprised of pre-formed insulation segments.

5. The method according to claim 2, wherein the sleeve is comprised of a heat-shrinkable material, and sealing the sleeve comprises applying heat to the sleeve.

6. The method according to claim 2, wherein sealing the sleeve comprises welding the sleeve to each of the respective outer jackets of the carrier pipe sections.

7. The method according to claim 2, wherein sealing the sleeve comprises applying a sealant band around a segment of each of the respective outer jackets of the carrier pipe sections to form a seal between the sleeve and each of the respective outer jackets.

8. The method according to claim 2, wherein testing for loss of air pressure inside the cavity results in detection of a leak of the cavity, and further comprising repairing the leak before permanently sealing the bore of the air tube.

9. A piping system comprising a field joint formed between adjacent pipe sections, each pipe section comprising an inner carrier pipe disposed inside an outer jacket with a space between the carrier pipe and the outer jacket, wherein the field joint is formed by:
forming a carrier pipe joint between ends of the carrier pipe of each of the pipe sections;
positioning an air tube so that a first end of the air tube is positioned within a joint area of the adjacent pipe sections, with a second end of the air tube positioned to extend beyond the joint area;
placing a sleeve over the joint area so that the sleeve surrounds the joint area and extends beyond a gap between the respective outer jackets of the pipe sections, wherein the sleeve is positioned so that it covers the first end of the air tube and does not cover the second end of the air tube;
sealing the sleeve to each of the respective outer jackets of the pipe sections such that a sealed jacket joint is formed between the respective jackets so as to form a sealed cavity inside the sealed jacket joint, wherein the first end of the air tube is sealingly enclosed within the sealed cavity, and the second end of the air tube remains outside the sealed cavity and exposed to an outside environment;
injecting air into a bore of the air tube at the second end of the air tube to pressurize the sealed cavity;
closing off the bore of the air tube to maintain the air pressure in the cavity;
testing for loss of air pressure inside the cavity; and
then permanently sealing off the bore of the air tube.

10. The piping system according to claim 9, wherein each of the pipe sections is a pre-insulated carrier pipe section, wherein the space between the inner carrier pipe and the outer jacket along the longitudinal axis of the pipe section contains an insulating layer.

11. The piping system according to claim 10, wherein forming the field joint further comprises filling a gap between respective insulating layers of respective adjoining carrier pipe sections by adding insulation to the gap.

12. The piping system according to claim 11, wherein the insulation added to the gap is comprised of pre-formed insulation segments.

13. The piping system according to claim 10, wherein the sleeve is comprised of a heat-shrinkable material, and sealing the sleeve comprises applying heat to the sleeve.

14. The piping system according to claim 10, wherein sealing the sleeve comprises welding the sleeve to each of the respective outer jackets of the carrier pipe sections.

15. The piping system according to claim 10, wherein sealing the sleeve comprises applying a sealant band around a segment of each of the respective outer jackets of the carrier pipe sections to form a seal between the sleeve and each of the respective outer jackets.

16. The piping system according to claim 10, wherein testing for loss of air pressure inside the cavity results in detection of a leak, and forming the field joint further comprises repairing the leak before permanently sealing the bore of the air tube.
